(19) United States
(12) Patent Application Publication
(10) Pub. No.: US 2026/0340467 A1
(43) Pub. Date: Oct. 29, 2026

(54) QUANTUM COMPUTING ARRANGEMENT AND QUANTUM COMPUTER

(71) Applicant: eleQtron GmbH, Siegen (DE)

(72) Inventors: Michael Johanning, Siegen (DE); Sebastian Bock, Berlin (DE); Pedram Yaghoubi, Siegen (DE); Patrick Huber, Herdorf (DE); Patrick Barthel, Burbach (DE); Christof Wunderlich, Siegen (DE); Theeraphot Sriarunothai, Siegen (DE); Florian Köppen, Siegen (DE); Hendrik Siebeneich, Siegen (DE)

(21) Appl. No.: 19/113,652

(22) PCT Filed: Sep. 26, 2023
(86) PCT No.: PCT/EP2023/076502

§ 371 Date: Mar. 20, 2025

(30) Foreign Application Priority Data
Sep. 26, 2022 (DE) 10 2022 124 679.5

(51) Int. Cl. G06N 10/40

(52) U.S. Cl. CPC G06N 10/40

(57) ABSTRACT

In an embodiment a quantum computing arrangement includes a permanent magnet arrangement having a plurality of permanently magnetized segments, wherein the quantum computing arrangement is configured to realize a Paul trap configured for trapping ions along a predefined line, wherein each segment has a magnetization direction, and wherein the segments are arranged such that the magnetization directions of at least some segments differ from each other and such that a magnetic field is established, a magnitude of which changes along the predefined line.

### CROSS-REFERENCE TO RELATED APPLICATIONS

This patent application is a national phase filing under section 371 of PCT/EP2023/076502, filed Sep. 26, 2023, which claims the priority of German patent application no. 102022124679.5, filed Sep. 26, 2022, each of which is incorporated herein by reference in its entirety.

### TECHNICAL FIELD

The present disclosure relates to a quantum computing arrangement and a quantum computer.

### BACKGROUND

In many quantum computing processes using quantum computing arrangements, the arrangements are configured to trap quantum particles, like ions. During operation, the trapped quantum particles form quantum bits, qubits for short. The trapped quantum particles have to be controlled and manipulated in order to perform calculations. For the trapped quantum particles, an interaction as e.g. Coulomb repulsion may create a coupling of neighbouring trapped quantum particles and, thus, enables entanglement. In order to perform quantum computing processes using the trapped quantum particles, the trapped quantum particles have to be controllable and addressable individually from one another.

An individual addressing of a plurality of trapped quantum particles, e.g. a quantum bit register, is desirable with negligible crosstalk. However, crosstalk between neighbouring trapped quantum particles is typically a difficult source of error to control in a quantum computer process and can prevent meaningful application of quantum error correction protocols and thus scalability.

### SUMMARY

Embodiments provide an improved quantum computing arrangement, for instance a quantum computing arrangement allowing for an improved controllability. Further embodiments provide a quantum computer with such a quantum computing arrangement.

Firstly, the quantum computing arrangement is specified.

According to at least one embodiment, the quantum computing arrangement comprises a permanent magnet arrangement. The permanent magnet arrangement comprises a plurality of permanently magnetized segments.

The segments may all be formed identically within the limits of manufacturing tolerances. For example, the permanent magnet arrangement is symmetric, particularly geometrically symmetric, with respect to a symmetry plane. This means that the geometry or shape, respectively, of the permanent magnet arrangement is symmetric with respect to the symmetry plane. The geometry of the permanent magnet arrangement may also have a rotational symmetry, e.g. an n-fold rotational symmetry with n being at least 3 or at least 4 or at least 6 or at least 8.

The permanent magnet arrangement may comprise at least four or at least eight or at least 16 or at least 32 segments. Each segment comprises or consists of a permanent magnetic material. For example, the permanent magnetic material is a ferromagnetic material. The segments may each comprise or consist of the same material. Each segment is formed, for example, in one piece. Alternatively, each segment is formed of at least two sub-segments, wherein the at least two sub-segments have the same material and/or magnetization properties.

According to at least one embodiment, the quantum computing arrangement is configured to realize a Paul trap for trapping ions along a predefined line, i.e. the ions are lined up along the predefined line. In other words, during operation, the quantum computing arrangement, i.e. at least a portion thereof, constitutes a Paul trap. A Paul trap is also known as quadrupole ion trap or radio frequency (RF) trap. It is a type of ion trap that uses dynamic electric fields to trap charged particles.

A Paul trap comprises a plurality of electrodes, for example at least two RF-electrodes, at least two DC-electrodes and at least two end-cap electrodes. The electrodes may be different from the permanently magnetized segments of the permanent magnet arrangement. Therefore, the Paul trap may be a separate device of the quantum computing arrangement being different from the permanent magnet arrangement. Alternatively, one or more of the segments of the permanent magnet arrangement also form electrodes of the Paul trap so that the Paul trap is at least partially formed by the permanent magnet arrangement.

The Paul trap is configured to trap 2 or more, e.g. at least 8 or at least 20 or at least 100 and/or at most 1000, ions along the predefined line.

During operation, the electrodes of the Paul trap create an oscillating electrical potential configured to trap the ions in directions parallel to the predefined line and in directions perpendicular to the predefined line, herein also referred to as radial directions. Effectively, at least one electrical potential well is created in which the ions are trapped in all special directions and which is formed such that the ions arrange along the predefined line one behind the other. A plurality of ions trapped in the same static electrical potential well is herein also referred to as an ion crystal.

The predefined line, also called trap line, is defined by the electrical potential produced by the Paul trap and, thus, is dependent on the geometry of the Paul trap. The trapped ions are arranged along the predefined line. For example, each of the ions intersects with the predefined line and/or oscillates around the predefined line. In other words, in the Paul trap, the ions are arranged in an ion chain extending along the predefined line.

Besides the electrodes for the Paul trap, the quantum computing arrangement may comprise components for powering the electrodes, like a power supply and/or control units.

According to at least one embodiment, each segment has a magnetization direction. A magnetization of each segment is defined by a vector field being representative of dipole moments of the respective permanent magnetic material. This is to say that the respective permanent magnetic material exhibits dipole moments. The vector field, in particular the dipole moments of the permanent magnetic material, define the respective magnetization direction. The dipole moments largely point in the magnetization direction.

According to at least one embodiment, the segments are arranged such that the magnetization directions of at least some segments differ from each other such that the permanent magnet arrangement establishes a magnetic field. The magnitude of the magnetic field changes along the predefined line.

For example, the magnetization directions of every two directly neighbouring segments are different from each other. The magnetization directions may differ from each other by an angle of at least 5° or at least 10° and/or at most 90° or at most 45°. By way of example, if there are m segments, wherein m is an even natural number of at least 4, the magnetization directions of each two directly neighbouring segments are rotated by 360°·3/m with respect to one another.

The vector field defined by the magnetization directions of the segments and the position of the segments in space may be symmetric with respect to the above-mentioned symmetry plane. Particularly, this vector field can have the same symmetry as the geometry of the permanent magnet arrangement. Alternatively, the vector field may asymmetric with respect to the symmetry plane and/or may have a different symmetry than the geometry of the permanent magnet arrangement or may be even asymmetric.

The magnetic field is herein understood to be the magnetic flux density. Accordingly, the magnitude of the magnetic field is the absolute value of the magnetic flux density.

The magnetic field created by the permanent magnet arrangement is or comprises, for example, a magnetic quadrupole field. Also higher multipole moments may exist. In a center of the magnetic field, the absolute value of the magnetic field may be zero. The center of the magnetic field may coincide with a geometrical center of the permanent magnet arrangement and/or of the Paul trap. For example, the center of the magnetic field lies in the symmetry plane of the permanent magnet arrangement and/or on the predefined line. The magnetic field may be point symmetric with respect to its center.

The magnitude of the magnetic field changes along the predefined line. This means that the magnitudes of the magnetic field at different positions on the predefined line are different from each other. The change of the magnitude of the magnetic field along the predefined line is herein also referred to as gradient of the magnetic field along the predefined line.

The change of the magnitude of the magnetic field may be monotone, e.g. strictly monotone, at least in sections. For example, starting from the center of the magnetic field, the change of the magnetic field may be monotone or strictly monotone in both directions along the predefined line. The direction of the magnetic field may change along the predefined line or may stay constant along the predefined line.

In at least one embodiment, the quantum computing arrangement comprises a permanent magnet arrangement having a plurality of permanently magnetized segments. The quantum computing arrangement is configured to realize a Paul trap for trapping ions along a predefined line. Each segment has a magnetization direction. The segments are arranged such that the magnetization directions of at least some segments differ from each other and such that a magnetic field is established, the magnitude of which changes along the predefined line.

Trapped ions provide excellent quantum systems for quantum control and metrology. In embodiments of the present invention, they are stored in a Paul trap and form at least one ion crystal orientated along a predefined line. For quantum computing with trapped ions as well as for certain tasks in metrology, individual control over single ions is desirable. When ions are manipulated by RF radiation, this single ion control cannot be achieved by focusing radiation, as the wavelength normally exceeds the ion separation in the ion crystal by orders of magnitude. Also, the coupling of the internal and external quantum states, quantified by the Lamb-Dicke parameter, cannot be achieved by RF radiation.

Embodiments of the present invention are, inter alia, based on the idea to use an inhomogeneous magnetic field provided by a permanent magnet arrangement to resolve the degeneracy of the resonances of the individual trapped ions. This provides the possibility to individually address the ions in the frequency space by means of RF radiation. On the other hand, the superposition of the electrical potential caused by the Paul trap with the magnetic field of the permanent magnet arrangement makes the equilibrium positions of the ions dependent on their respective quantum state. As a consequence of this, an effective spin-spin coupling is achieved by the Coulomb interaction between the trapped ions. This enables entanglement of the quantum states of the ions.

In summary, using the described quantum computing arrangement for quantum information processing enables advanced addressing in frequency space and thus individual single qubit rotations with low cross-talk, and introduces an effective coupling between the ions, thus enabling multi-qubit gates. This can also be used in connection with RF frequencies, for which addressing by focusing radiation is not an option due to the long wavelength, but RF fields might offer advantages in terms of miniaturization, integration. According to at least one embodiment, the permanent magnet arrangement comprises NdFeB. In particular, the permanent magnet arrangement comprises NdFeB N52. Exemplarily, each segment comprises or consists of NdFeB, in particular NdFeB N52.

According to at least one embodiment, the segments are arranged in a Halbach arrangement. A Halbach arrangement is a special arrangement of permanent magnets that augments the magnetic field on one side of the arrangement and cancels the field to near zero on the other side. Particularly, this is achieved by having a spatially rotating pattern of the magnetization directions of the segments.

With such a Halbach arrangement, particularly high magnetic fields and field gradients can be achieved. Since the effective spin-spin coupling as well as the differences in the resonances of neighbouring ions is dependent on the inhomogeneity and the magnitude of the magnetic field, a Halbach arrangement is particularly useful. Indeed, the Halbach arrangement allows for large gradients even when the distance between any surface (including the surfaces of trap electrodes and magnets) and trapped ions should be large which is desirable for high fidelity gates with trapped ions.

According to at least one embodiment, the permanent magnet arrangement surrounds the Paul trap. That is to say, the Paul trap is a separate device from the permanent magnet arrangement. Particularly, the segments of the permanent magnet arrangement are different from the electrodes of the Paul trap. For example, the permanent magnet arrangement has the shape of a ring or the shape of a contour or periphery, respectively, of a polygon. Thus, the Paul trap may be surrounded by a ring-shaped or polygon-contour-shaped permanent magnet arrangement. The permanent magnet arrangement may then augment the magnetic field in the interior of the ring or contour and cancel the field to near zero outside the ring or contour other side.

According to at least one embodiment, at least some electrodes of the Paul trap are formed by segments of the permanent magnet arrangement. For example, the end cap electrodes are formed by segments of the permanent magnet arrangement.

According to at least one embodiment, the Paul trap is a linear Paul trap for trapping ions along a predefined straight line or axis, respectively. Thus, the predefined line is a predefined straight line or predefined axis, respectively. Alternatively, the Paul trap may be a circular Paul trap.

According to at least one embodiment, the quantum computing arrangement further comprises a yoke structure for increasing the magnetic field and/or the change of the magnitude of the magnetic field along the predefined line established by the permanent magnet arrangement. The yoke structure is particularly arranged such that it increases the magnetic field or magnetic field gradient in the region of the trapped ions, i.e. along the predefined line. For example, the yoke structure comprises or consists of a soft magnetic material. It may have a coercivity being at most 1000 A/m or at most 100 A/m. The soft magnetic material may be a ferromagnetic material configured to be magnetized by the magnetic field established by the permanent magnet arrangement. The soft magnetic material may have a relative magnetic permeability of at least 300 or at least 1000 or at least 10000. Exemplarily, the soft magnetic material has a relative magnetic permeability of about 12000. A saturation flux density of the soft magnetic material may be at least 0.5 T or at least 2 T. For example, the soft magnetic material comprises at least one of: iron, cobalt, vanadium, manganese, niobium, silicon, carbon.

The yoke structure may extend along or parallel to the predefined line. For example, the yoke structure comprises at least two portions spaced apart from each other in a direction parallel to the predefined line. Each of the two portions may be elongated, for example with a main extension direction parallel to or along the predefined line. That is, the elongated portions may be orientated parallel to the predefined line. The portions of the yoke structure may intersect with the predefined line.

The steepness of the magnetic gradient can be further enhanced by using the yoke structure to concentrate the magnetic flux. The yoke structure is, for example, placed in regions, where the magnetic field of the permanent magnet arrangement is already of small magnitude and concentrates it to the small cross section of the yoke structure without exceeding the saturation magnetization of the yoke structure, thus substantially boosting the magnitude of achievable gradients, allowing for lower cross-talk, stronger couplings and faster quantum gates.

According to at least one embodiment, the yoke structure is at least partially formed by components of the quantum computing arrangement constituting end-cap electrodes of the Paul trap (in the following simply referred to as end-cap electrodes of the Paul trap). The end-cap electrode, independently of whether they are part of the yoke structure or not, are, for example, formed as elongated elements extending parallel to or along the predefined line. The end cap electrodes may each comprise a cylindrical main body. Furthermore, each end cap electrode may comprise a tapering portion, e.g. a cone formed portion. The tapering portions taper towards each other or towards the trapped ions, respectively.

For example, each of the end-cap electrodes constitutes a portion of the yoke structure. The end-cap electrodes may intersect with the predefined line.

Also further electrodes of the Paul trap may be part of the yoke structure. In other words, at least some electrodes of the Paul trap may comprise or consist of a soft magnetic material in order to increase the magnetic field or the magnetic field gradient established by the permanent magnet arrangement.

According to at least one embodiment, the yoke structure is arranged between end-cap electrodes of the Paul trap. For example, the portions of the yoke structure are arranged in between the end cap electrodes in a direction parallel to the predefined line.

According to at least one embodiment, the yoke structure comprises or consist of an iron-cobalt alloy. The iron-cobalt alloy may comprise vanadium, e.g. with a concentration of at least 1.5% and at most 3%.

According to at least one embodiment, the quantum computing arrangement comprises a vacuum chamber. During operation, the ions are trapped in the vacuum chamber. The Paul trap or the electrodes thereof may also be arranged in the vacuum chamber. The vacuum chamber may be an ultra-high vacuum chamber, an extreme-high vacuum chamber and/or a cryostat.

According to at least one embodiment, the permanent magnet arrangement is arranged outside of the vacuum chamber. This can be advantageous since the creation of ultra-high vacuum, UHV for short, can involve steps such as baking, which can be incompatible with many magnetic materials, especially those with low Curie temperature. The permanent magnet arrangement still creates a sufficiently high magnetic field or field gradient in the area of the ions even when located outside of the vacuum chamber. Alternatively, the permanent magnet arrangement can also be located inside the vacuum chamber. The optional yoke structure may be arranged inside or outside the vacuum chamber and may increase the magnetic field (gradient).

According to at least one embodiment, the permanent magnet arrangement establishes a substantially two-dimensional magnetic field which is mainly concentrated in the magnetic field plane. The center of the magnetic field may lie in the magnetic field plane. The symmetry plane of the permanent magnet arrangement is, for example, perpendicular to the magnetic field plane. For example, all of the segments of the permanent magnet arrangement are arranged in the magnetic field plane.

When starting from the magnetic field plane and moving in directions perpendicular to the magnetic field plane, the magnetic field decays, e.g. the average magnitude of the magnetic field decays to almost zero. The decay length depends on the dimensions of the permanent magnet arrangement, e.g. on the inner and/or outer radius and/or the thickness of the segments measured perpendicular to the magnetic field plane. Particularly, the decay length is proportional to the inner and/or outer radius and the thickness of the segments.

For instance, the average magnitude of the magnetic field has a Full Width Half Maximum (FWHM) of at least 1 μm or at least 10 μm and/or at most 10 mm or at most 500 μm in direction perpendicular to the magnetic field plane. For example, in this case, the average magnitude of the magnetic field outside the magnetic field plane, e.g. at a distance of 1 mm from the magnetic field plane, is at least one order of magnitude smaller than the average magnitude of the magnetic field in the magnetic field plane. In other words, the magnetic field plane is a main extension plane of the magnitude of the magnetic field.

For example, with the segments of the permanent magnet arrangement arranged in the form of a ring with the main extension plane of the ring defining the xy-plane, the magnetic flux density \vec{B} corresponding to the magnetic field is:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) .$$

BR is the remanence of the segments, Ri the inner radius of the ring, Ro the outer radius of the ring and x and y are the coordinates within the permanent magnet arrangement. In this case, the magnetic field plane is the xy-plane or the main extension plane of the ring, respectively.

According to at least one embodiment, the predefined line extends parallel to the magnetic field plane. For example, the predefined line extends in the magnetic field plane.

According to at least one embodiment, components of the quantum computing arrangement constituting RF-electrodes of the Paul trap, in the following simply referred to as RF-electrodes of the Paul trap, are arranged outside of the magnetic field plane. For example, two RF-electrodes of the Paul trap are arranged on different sides of the magnetic field plane. Likewise, DC-electrodes of the Paul trap may be arranged outside of the magnetic field plane and are, for example, arranged on different sides of the magnetic field plane.

According to at least one embodiment, end-cap electrodes of the Paul trap are arranged in the magnetic field plane, i.e. intersect with the magnetic field plane. For example, the end-cap electrodes are arranged on the predefined line, i.e. intersect with the predefined line. Alternatively, the end-cap electrodes may each be segmented in at least two sub-electrodes with two sub-electrodes of each end-cap electrode being arranged on different sides of the magnetic field plane, e.g. symmetrical with respect to the magnetic field plane.

For example, the Paul trap comprises at least two end-cap electrodes and at least four radial electrodes. The end-cap electrodes may be arranged on the predefined line and spaced from each other in a direction parallel to the predefined line. The radial electrodes may be arranged around the predefined line. The radial electrodes may be blade electrodes. Two of the radial electrodes may be RF-electrodes which, during operation, are supplied with an alternating voltage. Two other of the radial electrodes may be DC-electrodes which, during operation, are on a static potential, e.g. on ground. The RF-electrodes are, for example, diagonally opposite each other.

Instead of a Paul trap with electrodes being arranged on opposite sides of the magnetic field plane generated by the permanent magnet arrangement, the Paul trap may be a so-called planar Paul trap with all electrodes arranged in a common electrode plane and, for example, being arranged on one side of the magnetic field plane.

According to at least one embodiment, the segments of the permanent magnet arrangement are arranged in the magnetic field plane. This means, for example, each of the segments intersects with the magnetic field plane.

According to at least one embodiment, the Paul trap is configured to trap ¹⁷¹Yb⁺ ions.

According to at least one embodiment, the Paul trap is configured such that, during operation, a minimum distance of directly neighbouring trapped ions is at least 0.1 μm or at least 1 μm and/or at most 30 μm or at most 20 μm. The minimum distance of directly neighbouring trapped ions is, for example, 5 μm. The distances of directly neighbouring trapped ions may vary along the predefined line. For example, two different neighbouring ion crystal may have a larger distance, e.g. at least 50 μm or at least 100 μm. The distance between the ions may be set by setting the electrical potentials of the electrodes of the Paul trap.

According to at least one embodiment, the trapped ions each have a σ±-transition in which the magnetic quantum number changes, wherein a frequency difference of the σ±-transitions between directly neighbouring trapped ions is at least 50 kHz or at least 100 kHz or at least 1 MHz and/or at most 100 MHz. The frequency difference of the σ±-transition between directly neighbouring trapped ions is, for example, between 15 MHz and 50 MHz. σ±-transitions can be excited by a left- or right-circularly polarised electromagnetic wave.

According to at least one embodiment, the trapped ions each have a n-transition, in which the magnetic quantum number does not change, wherein a frequency difference of the π-transitions between directly neighbouring trapped ions is at least 200 Hz or at least 1 kHz and/or at most 10 MHz. The frequency difference of the π-transition between directly neighbouring trapped ions is, for example, between 0.001 MHz and 0.5 MHz. Such a π-transition is excited by a linearly polarised electromagnetic wave with a polarization parallel to the local magnetic field.

According to at least one embodiment, edges of segments of the permanent magnet arrangement being arranged at opposite regions and facing one another have a minimum distance from one another of at least 10 μm or at least 0.01 cm and/or at most 100 cm. In this context, opposite means, for example, opposite with respect to a center of gravity of the permanent magnet arrangement and/or with respect to the center of the magnetic field.

According to at least one embodiment, each segment has an extent along the corresponding minimal distance of at least 10 μm or at least 0.01 cm and/or at most 100 cm. For example, each segment is formed as a ring segment. The extent along the minimum distance is then the radial extension of that segment.

According to at least one embodiment, a remanence of each of the segments of the permanent magnet arrangement is at least 0.5 T and/or at most 5 T.

According to at least one embodiment, the change of the magnetic field along the predefined line, for example in the center of the magnetic field, is at least 0.5 T/m or at least 50 T/m or at least 100 T/m and/or at most 500 T/m. This can be achieved, for example, with the minimal distance between opposite segments and the remanence of the segments as specified above.

Next, the quantum computer is specified. The quantum computer comprises a quantum computing arrangement as described herein. Therefore, all features disclosed for the quantum computing arrangement are also disclosed for the quantum computer and vice versa.

The quantum computer is configured to perform quantum computing processes by using the quantum computing arrangement. The trapped ions of the quantum computing arrangement can be controlled and manipulated particularly well with the permanent magnet arrangement described herein in order to perform predetermined quantum calculations.

According to at least one embodiment, the quantum computer further comprises a cooling and/or read-out system. The cooling and/or the read-out system is, for example, laser-based. The cooling system is configured for cooling the ions in order to prepare them in low motional states and trap them in their respective ground states. The read-out system is configured for determining the state of each ion. For example, the ions are cooled and/or read-out by impinging a laser beam on them or by scattering photons of the laser beam, respectively.

### BRIEF DESCRIPTION OF THE DRAWINGS

Hereinafter, the quantum computer arrangement and the quantum computer will be explained in more detail with reference to the drawings on the basis of exemplary embodiments. The accompanying figures are included to provide a further understanding. In the figures, elements of the same structure and/or functionality may be referenced by the same reference signs. It is to be understood that the embodiments shown in the figures are illustrative representations and are not necessarily drawn to scale. In so far as elements or components correspond to one another in terms of their function in different figures, the description thereof is not repeated for each of the following figures. For the sake of clarity, elements might not appear with corresponding reference symbols in all figures.

FIGS. 1, 5 and 6 show different exemplary embodiments of the quantum computing arrangement;

FIGS. 2 and 3 show a detailed view of an exemplary embodiment of the Paul trap in different views;

FIG. 4 shows a further exemplary embodiment of a Paul trap; and

FIG. 7 shows an exemplary embodiment of a quantum computer.

### DETAILED DESCRIPTION OF ILLUSTRATIVE EMBODIMENTS

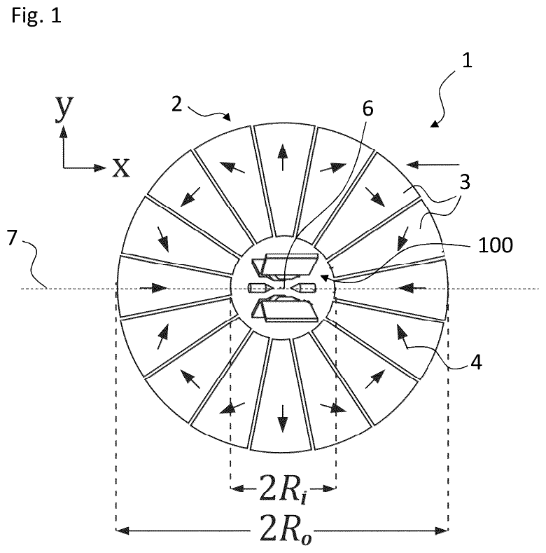

FIG. 1 shows a first exemplary embodiment of the quantum computing arrangement 1. The quantum computing arrangement 1 comprises a permanent magnet arrangement 2. The permanent magnet arrangement 2 comprises 16 permanently magnetized segments 3. The segments 3 surround a Paul trap 100. The Paul trap 100 is configured to trap a plurality of ions 6 along a predefined line 7 or trap line 7, respectively. In this exemplary embodiment, the Paul trap 100 is a linear Paul trap for trapping the ions 6 along a straight line 7. The straight line 7 defines an x-axis.

The permanent magnet arrangement 2 has the shape of a ring with the Paul trap 100 being arranged in the center of the ring. The thickness of each segment 3 is, e.g., about 100 μm. The ring spans a xy-plane. Each segment 3 has the shape of a ring segment. The minimum distance between two opposite segments 3, i.e. the inner ring diameter 2Ri, is approximately 10 cm. Furthermore, each segment 3 has an extent along the corresponding minimal distance being approximately 20 cm. The outer diameter 2Ro of the permanent magnet arrangement 2 is, accordingly, approximately 50 cm. Edges of directly neighbouring segments 3 facing one another, have a distance to one another of approximately 10 mm, for example.

Furthermore, each segment 3 has a magnetization direction 4 being depicted as arrows within the segments 3 in FIG. 1. The segments 3 are each formed of NdFeB N52, for example. The magnetization directions 4 of segments 3 being arranged at opposite regions with respect to a center of the permanent magnet arrangement 2 are directed in opposite directions. The predefined line 7 runs through the center of the permanent magnet arrangement 2 and intersects with two opposite segments 3, wherein the magnetization directions 4 of these two segments 3 are parallel to the predefined line 7.

Each magnetization direction 4 encloses an angle with the predefined line 7. All of these angles are formed different to one another. For example, the angles of each two directly neighbouring segments 3 differ by 67.5° from one another. The magnetization directions 4 are all in the xy-plane.

The permanent magnet arrangement of FIG. 1 is a Halbach arrangement establishing a magnetic quadrupole field with a magnitude of the magnetic field changing along the predefined line 7. In other words, the magnetic field has a magnetic field gradient along the predefined line 7. For example, each of the trapped ions arranged along the predefined line sees a different magnetic field.

With the permanent magnet arrangement of FIG. 1, the following idealized magnetic flux density B is produced:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) .$$

The remanence B_{R} of each of the segments 3 is, for example, 1 T. As can be extracted from this idealized magnetic flux density, the magnetic field is mainly a two-dimensional magnetic field which is concentrated in the xy-plane which constitutes a magnetic field plane.

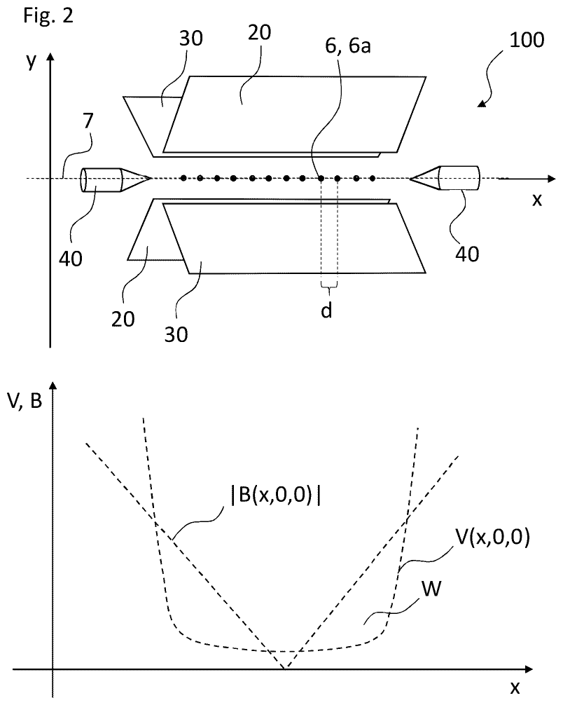

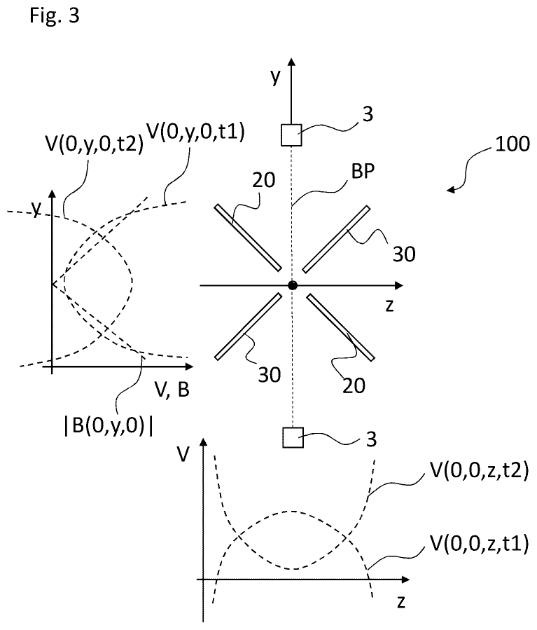

FIGS. 2 and 3 shows a detailed view of the Paul trap 100 of FIG. 1. In FIG. 2, the xy-plane is indicated. FIG. 3 is a plan view of the yz-plane, i.e. a view along the x-axis.

The Paul trap 100 comprises two end-cap electrodes 40 and four radial electrodes 20, 30. Two radial electrodes 20 being arranged diagonally opposite and on different sides of the magnetic field plane BP (xy-plane) are RF-electrodes which are supplied with alternating voltage during operation. The other two diagonally opposite radial electrodes 30 are DC-electrodes which are operated on a constant electrical potential, e.g. on ground.

The end-cap electrodes 40 are operated with a static electrical potential. The electrical potential V(x,0,0) along the x-axis created by the Paul trap 100 is illustrated in FIG. 2.

FIG. 3 illustrates the electrical potential on the y- and z-axis created by the Paul trap 100. At time t1, the electrical potential V(0,y,0,t1) along the y-axis is attractive. At this time t1, the electrical potential V(0,0,z,t1) along the z-axis is repulsive or defocussing, respectively. At time t2, namely after half an RF cycle, the electrical potential V(0,0,z,t2) along the z-axis is attractive. Along the y-axis, the electrical potential V(0,y,0,t2) is repulsive or defocusing, respectively. With these alternating potentials in y- and z-direction an attractive pseudo-potential is formed so that the ions 6 are finally trapped in radial direction.

In total, due to the electrical potentials in the different directions, a potential well W is formed which traps the ions 6. The ions 6 in the potential well W arrange in a linear ion crystal 6a as shown in FIG. 2.

FIGS. 2 and 3 also indicate the magnitude of the electric field, namely of magnetic flux density |B|, established by the permanent magnet arrangement 2. As can be seen, the magnitude of the magnetic flux density |B| changes in x-direction and y-direction, i.e. along the magnetic field plane BP. In a center of the magnetic field, the magnitude of the magnetic field is 0.

The ions 6, shown in FIGS. 1 to 3, are, e.g., ¹⁷¹Yb⁺ ions. Distances d of directly neighbouring trapped ions are approximately 3 μm. The degeneracy of the excited quantum state is resolved by the magnetic field generated by the permanent magnet arrangement 2. The energy for the r-transition from the ground quantum state to the excited m=0 quantum state depends weakly on the magnetic field seen by the ion. Likewise, the energies of the σ-transitions from the ground quantum state to the excited m=±1 quantum state depend on the magnetic field seen by the ion. Since the magnitude of the magnetic field depends on the position of the ion 6 along the predefined line 7, the energies of the transitions depend on the position along the predefined line 7. For example, for each two neighbouring ions 6, a frequency difference for the σ±-transition is at least 1 MHz and at most 100 MHz. Moreover, for each two neighbouring ions 6, a frequency difference of the r-transitions is at least 0.001 MHz and at most 10 MHz.

Moreover, due to the form of the potential well along the predefined line 7 and the magnetic field provided by the permanent magnet arrangement 2, the equilibrium positions of the ions 7 depend on their respective quantum state. Thus, an effective spin-spin coupling between the ions 6 due to Coulomb interaction is realized. This allows the quantum states of the ions 6 to be entangled.

In particular, a coupling strength between two directly neighbouring trapped ions 6 depends on the square of the magnetic field gradient. Furthermore, a relaxation time, in particular a spin relaxation time T2, is inversely proportional to the decoherence rate. Thus, in order to provide multi-qubit gates, the magnetic field gradient has to be comparatively high to provide a large number of gates within a given time. This can be achieved with the permanent magnet arrangement described herein.

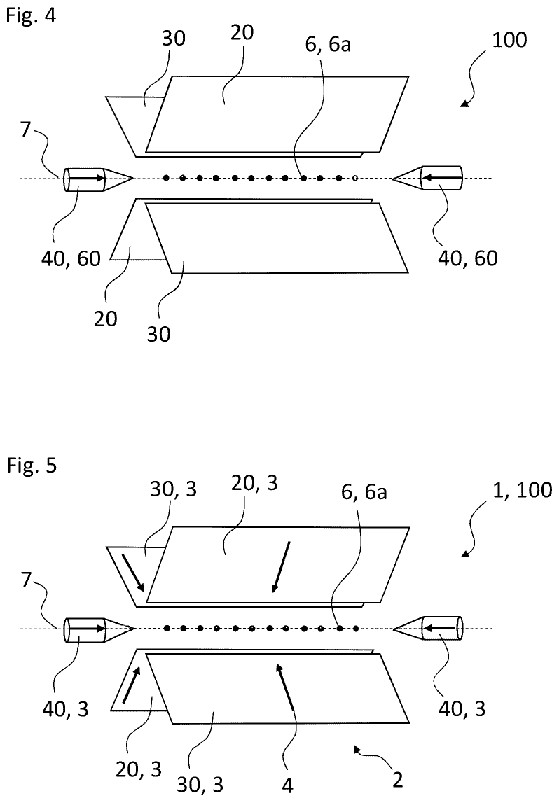

FIG. 4 shows a further exemplary embodiment of the Paul trap 100, in which the end-cap electrodes 40 are part of a yoke structure 60. The yoke structure 60 is configured to increase the magnetic field along the predefined line 7 in the area where the ions 6 are trapped. Each of the end-cap electrodes 40 forms an elongated portion of the yoke structure 60. For example, the end-cap electrodes 40 are made from a soft magnetic material, like Hiperco® 50.

FIG. 5 shows a further exemplary embodiment of the quantum computing arrangement 1 or the Paul trap 100, respectively. In contrast to the previous exemplary embodiments, the permanent magnet arrangement 2 is not separate from the Paul trap 100, but, instead, the Paul trap 100 itself forms the permanent magnet arrangement 2. This is realized by the different electrodes 20, 30, 40 forming the segments 3 of the permanent magnet arrangement 2. Each electrode 20, 30, 40 is made of a ferromagnetic material and has a magnetization direction 4. The magnetization directions 4 of at least some of the electrodes 20, 30, 40 differ from each other, thereby establishing a magnetic field with the magnitude of the magnetic field changing along the predefined line 7.

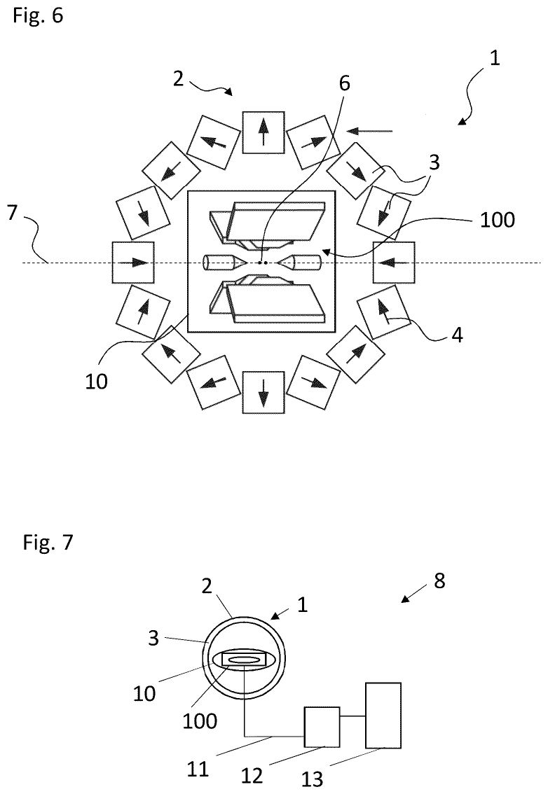

In the exemplary embodiment of FIG. 6, the permanent magnet arrangement 2 surrounds the Paul trap 100 in the form of a contour of a polygon. Each segment 3 has the form of a square. Neighbouring segments 3 are rotated with respect to each other.

As can be further seen in FIG. 6, the Paul trap 100 is arranged in a chamber 10 and the chamber 10 is surrounded by the permanent magnet arrangement 2. The chamber 10 is, e.g., an ultra-high vacuum chamber.

An exemplary embodiment of a quantum computer 8 is shown in FIG. 7. The quantum computer 8 comprises a quantum computing arrangement 1 according to one of the exemplary embodiments described herein. The Paul trap 100 is connected to components of the quantum computer 8 through the chamber 10 by a plurality of connections 11. For instance, the connections 11 connect the Paul trap 100 with external control electronics 12 and a classical computer 13.

The quantum computing arrangement 1 is configured to trap, manipulate and measure trapped ions. For this, the quantum computing arrangement 1 may comprise, besides the permanent magnet arrangement 2 and any components of the Paul trap 100, light guides and/or internal electronics comprising electronic devices. The electronic devices can comprise circuitry, integrated electronics, power supply and/or detectors, such as photon detectors and/or charge detectors, controllers etc. Exemplarily, the internal electronics are provided for pre-processing. For example, these components allow a measurement of a respective state of the ion and allow gate operations on the ion. Thus, the quantum computing arrangement 1 is configured to trap the ions as well as to carry out operations and measurements on the trapped ions.

The Paul trap 100 is mounted in a chamber 10, wherein the chamber 10 can be an ultra-high vacuum chamber, an extreme-high vacuum chamber and/or a cryostat. It is possible that the permanent magnet arrangement 2 is arranged outside the chamber 10. In this case the permanent magnet arrangement 2 surrounds the chamber 10. Alternatively, it is possible that the permanent magnet arrangement 2 is arranged inside the chamber 10 (not shown here).

The quantum computing arrangement 1, particularly the Paul trap 100, is connected to the external electronics 12 via the connections 11. The external electronics 12 can be located at least partially inside and partially outside the chamber 10. Further, the external electronics 12 is connected to the classical computer 13.

The external electronics 12 comprises, for instance, analog to digital converters as well as signal generators such as radio frequency generators, microwave signal generators, low-frequency signal generators and/or direct current signal generators. Furthermore, the external electronics 12 can comprise a transistor-transistor logic, TTL.

Additionally, the external electronic 12 can further comprise at least one laser-based system configured to cool the trapped ions. Further, the laser-based system can be configured to excite a particular state of the trapped ions and/or to read-out a particular state of the ions.

The classical computer 13 is configured, for example, to provide and receive digital signals. The digital signals correspond to control signals used for operations on the qubits/ions as well as to measurement signals corresponding to a state of the qubits.

The external electronics 12 is, inter alia, configured to convert the digital signals to analog signals and vice versa. Therefore, the external electronics 12 is configured to provide the converted analog signals for manipulating the ions (qubits) to the quantum computing arrangement 1. Further, the external electronics 12 is configured to provide measured analog signals from the quantum computing arrangement 1 to the classical computer 13 or to process such signals to directly initiate some response signal generated by the control electronics 12.

The classical computer 13 is exemplary configured to be provided with a specific algorithm, i.e. a predetermined quantum calculation solving a specific problem. The classical computer 13 is then configured to convert a compiled code corresponding to the algorithm to commands for the quantum computing arrangement 1. The commands are subsequently forwarded via the external control electronics 12 to the quantum computing arrangement 1. Furthermore, the classical computer 13 is configured to receive a measured outcome of the specific algorithm.

For example, all elements of the quantum computer 8, in particular all electronic elements of the quantum computer 8, are synchronized by an atomic clock reference, for example.

The invention is not limited to the exemplary embodiments by their description. Rather, the invention encompasses any new feature as well as any combination of features, which in particular includes any combination of features in the claims, even if this feature or combination itself is not explicitly indicated in the claims or exemplary embodiments.

1.-17. (canceled)

18. A quantum computing arrangement comprising:
a permanent magnet arrangement comprising a plurality of permanently magnetized segments,
wherein the quantum computing arrangement is configured to realize a Paul trap configured for trapping ions along a predefined line,
wherein each segment has a magnetization direction, and
wherein the segments are arranged such that the magnetization directions of at least some segments differ from each other and such that a magnetic field is established, a magnitude of which changes along the predefined line.

19. The quantum computing arrangement according to claim 18, wherein the segments are arranged in a Halbach arrangement.

20. The quantum computing arrangement according to claim 18, wherein the permanent magnet arrangement surrounds the Paul trap in form of a ring or in form of a contour of a polygon.

21. The quantum computing arrangement according to claim 18, wherein at least some electrodes of the Paul trap are formed by segments of the permanent magnet arrangement.

22. The quantum computing arrangement according to claim 18, wherein the Paul trap is a linear Paul trap configured for trapping ions along a predefined straight line.

23. The quantum computing arrangement according to claim 18, further comprising a yoke structure configured for increasing the magnetic field and/or the changing the magnitude of the magnetic field along the predefined line established by the permanent magnet arrangement.

24. The quantum computing arrangement according to claim 23, wherein the yoke structure at least partially comprises end-cap electrodes of the Paul trap.

25. The quantum computing arrangement according to claim 23, wherein the yoke structure comprises a soft magnetic material.

26. The quantum computing arrangement according to claim 18, further comprising a vacuum chamber configured to trap the ions, wherein the permanent magnet arrangement is arranged outside the vacuum chamber.

27. The quantum computing arrangement according to claim 18,
wherein the permanent magnet arrangement establishes a substantially two-dimensional magnetic field, which is mainly concentrated in a magnetic field plane, and
wherein the predefined line extends parallel to the magnetic field plane.

28. The quantum computing arrangement according to claim 27, wherein RF-electrodes of the Paul trap are arranged outside of the magnetic field plane and on different sides of the magnetic field plane.

29. The quantum computing arrangement according to claim 27, wherein end-cap electrodes of the Paul trap are arranged in the magnetic field plane.

30. The quantum computing arrangement according to claim 27, wherein the segments are arranged in the magnetic field plane.

31. The quantum computing arrangement according to claim 18,
wherein the Paul trap is configured to trap ¹⁷¹Yb⁺ ions such that a minimum distance of directly neighbouring trapped ions is at least 0.1 μm and at most 30 μm, and
wherein each trapped ion has a σ_{±}-transition, in which a magnetic quantum number changes, wherein a frequency difference of the σ_{±}-transitions between directly neighbouring trapped ions is at least 100 kHz and at most 100 MHz, and/or
wherein each trapped ion has a π-transition, in which the magnetic quantum number does not change, and wherein a frequency difference of the π-transitions between directly neighbouring trapped ions is at least 1 kHz and at most 10 MHz.

32. The quantum computing arrangement according to claim 18,
wherein edges of segments being arranged at opposite regions and facing one another have a minimal distance from one another of at least 10 μm and at most 100 cm, and
wherein each segment has an extent along the corresponding minimal distance of at least 10 μm and at most 100 cm.

33. A quantum computer comprising:
the quantum computing arrangement according to claim 18,
wherein the quantum computing arrangement is configured for performing quantum computations.

34. The quantum computer according to claim 33 further comprising:
a laser based cooling and/or read-out system.
